(19) United States
(12) Patent Application Publication
(10) Pub. No.: US 2019/0190057 A1
(43) Pub. Date: Jun. 20, 2019

(54) LITHIUM ION BATTERY

(71) Applicant: KURITA WATER INDUSTRIES LTD., Tokyo (JP)

(72) Inventors: Mitsuru NOZUE, Tokyo (JP); Minoru YAGI, Tokyo (JP)

(21) Appl. No.: 16/327,913

(22) PCT Filed: Aug. 28, 2017
(86) PCT No.: PCT/JP2017/030797

§ 371 Date: Feb. 25, 2019

(30) Foreign Application Priority Data
Sep. 1, 2016 (JP) 2016-171186
Dec. 27, 2016 (JP) 2016-253184

(51) Int. Cl. H01M 10/052; H01M 10/0569; H01M 10/0568; H01M 4/525

(52) U.S. Cl. CPC H01M 10/052; H01M 4/525; H01M 10/0568; H01M 10/0569

(57) ABSTRACT

A lithium ion battery E comprises a positive electrode terminal, a negative electrode terminal, and a battery case, which is an airtight container, and an electrode body is accommodated inside the battery case. The electrode body has a positive electrode current collector, a positive-electrode electrode plate, a negative electrode current collector, and a negative-electrode electrode plate, and the positive-electrode electrode plate and the negative-electrode electrode plate form a laminated structure via a separator. Further, a metal ion removal agent is placed in a gap portion in the battery case. The metal ion removal agent has a transition metal ion adsorption capability, and preferably has a moisture removal capability, and is preferably made of a zeolite, in particular, an A-type zeolite ion-exchanged with Ca. Such a lithium ion battery is capable of capturing transition metal ions dissolved from a positive electrode active material, which improves battery lifetime properties.

### TECHNICAL FIELD

The present invention relates to a lithium ion battery used in electronic equipment, automobiles and the like, and, in particular, relates to a lithium ion battery having improved battery lifetime properties.

### BACKGROUND ART

In recent years, large capacity and high-power type lithium ion batteries have been put to practical application. Since these lithium ion batteries have large capacity and high power, higher levels of safety and stability are required compared to conventional secondary batteries.

A typical constitution of these lithium ion batteries uses carbon for the negative electrode, and a lithium transition metal oxide such as lithium cobalt oxide for the positive electrode, and uses a compound where a lithium salt such as lithium hexafluorophosphate (LiPF₆) is added to an organic solvent which is a non-aqueous electrolyte such as ethylene carbonate or diethyl carbonate for the electrolytic solution. However, any material for each of the negative electrode, the positive electrode and the electrolyte suffices as long as lithium ions can be transported and charge-discharge can be performed by donating and accepting charges, and therefore, extremely numerous aspects can be adopted.

As the lithium salt, in addition to LiPF₆, a fluorine-based complex salt such as LiBF₄, or a salt such as LiN(SO₂Rf)₂.LiC(SO₂Rf)₃ (Rf═CF₃ or C₂F₅) is used in some cases. Moreover, as the lithium transition metal oxide as a positive electrode material, LiCoO₂, LiMn₂O₄, LiNiO₂, LiFePO₄, Li₂FePO₄F, LiCO_{1/3}N_{1/3}Mn_{1/3}O₂, Li (LiαNixMnyCoz)O₂ and the like are known.

Moreover, normally, in order to impart higher conductivity and safety to the electrolytic solution, as the organic solvent, a mixture of a cyclic carbonic acid ester-based high-dielectric-constant and high-boiling-point solvent such as ethylene carbonate, or propylene carbonate, and a low viscosity solvent such as a lower chain carbonic acid ester such as dimethyl carbonate, ethyl methyl carbonate, or diethyl carbonate is used, and further a lower fatty acid ester may be used in some cases.

Here, when the temperature inside the battery rises, the lithium transition metal oxide ionizes and dissolves from a high-potential positive electrode active material, which deteriorates the positive electrode active material. In addition, the dissolved transition metal element ions precipitate on the negative electrode, which deteriorates the negative electrode as well. This induces lowering of the battery capacity and reducing of the battery lifetime. The amount of the dissolved transition metal element ions tends to increase when the positive electrode potential is higher. In particular, when moisture is present inside the lithium ion battery even in a small amount, the lithium-containing electrolyte reacts with the moisture in the non-aqueous electrolyte and decomposes, and generates strong acid such as hydrofluoric acid (HF). The hydrofluoric acid accelerates the dissolution of the transition metal ions from the lithium transition metal oxide which is the positive electrode material.

Thus, for the purpose of preventing dissolution of transition metal ions by such hydrofluoric acid, Patent Document 1 discloses an additive for an electrode containing an amino compound having an amino group, where the oxidation potential to metal lithium is in a range of 3.8 to 4.2 V.

### PRIOR ART DOCUMENT

### Patent Document

[Patent Document 1] WO 2013/031045

### SUMMARY OF THE INVENTION

### Problems to be Solved by the Invention

According to the technique of Patent Document 1, dissolution of a transition metal from a lithium transition metal oxide can be suppressed by capturing an acid such as hydrofluoric acid by a neutralization reaction. However, it is not possible to capture the transition metal ions themselves dissolved from the high-potential positive electrode active material, and there is a problem in that deterioration of the lithium ion battery in a medium to long term cannot be avoided.

That is, from the perspective of improving the battery lifetime, it is desirable to have a lithium ion battery capable of capturing transition metal ions dissolved from a high-potential positive electrode active material, but such a lithium ion battery has not conventionally existed.

In light of the above problems, the present invention aims to provide a lithium ion battery capable of capturing transition metal ions dissolved from a positive electrode active material and having improved battery lifetime properties.

### Means for Solving the Problems

With a view to solving the above problems, the present invention provides a lithium ion battery having a laminated body sealed in a battery case, the laminated body comprising a positive electrode, a negative electrode, and a separator and being impregnated with a non-aqueous electrolytic solution, and lithium ions in the non-aqueous electrolytic solution being responsible for electrical conduction, wherein a metal ion removal agent is provided in the battery case (Invention 1).

According to the above invention (Invention 1), by placing a metal ion removal agent capable of adsorbing transition metal ions in the lithium ion battery case, it is possible to promptly absorb the transition metal ions dissolved from a positive electrode active material due to repeated charge-discharge and the like. Therefore, it is possible to prevent precipitation of the transition metal ions on the negative electrode, to suppress deterioration of the negative electrode and accompanying reduction of battery capacity and reduction of battery lifetime, and to keep the lithium ion battery in a stable state.

In the above invention (Invention 1), it is preferable that the metal ion removal agent have a metal ion removal capability as well as a moisture removal capability (Invention 2).

According to the above invention (Invention 2), since the metal ion removal agent absorbs a slight amount of moisture present inside the battery, it is possible to prevent a reaction of a lithium salt with the moisture and to suppress generation of hydrofluoric acid, and therefore, it is possible to suppress the dissolution itself of the transition metal from a lithium transition metal oxide.

In the above inventions (Inventions 1 and 2), it is preferable that the metal ion removal agent be made of an inorganic porous material (Invention 3). Moreover, it is preferable that the inorganic porous material be made of a zeolite (Invention 4). In particular, it is preferable that the zeolite be an A-type zeolite ion-exchanged with Ca (Invention 5).

According to the above inventions (Inventions 3 to 5), these metal ion removal agents are capable of promptly absorbing transition metal ions by ion-exchange capability of a zeolite or the like, and concurrently have moisture absorption properties, and therefore, it is possible to exert both effects of suppressing the generation of hydrofluoric acid with a single agent.

In the above invention (Invention 1), it is preferable that the metal ion removal agent be made of a carbon-based material (Invention 6).

According to the above invention (Invention 6), the carbon-based material is capable of promptly absorbing transition metal ions, and concurrently has moisture absorption properties, and therefore, it is possible to exert effects of suppressing the generation of hydrofluoric acid with a single agent.

In the above inventions (Inventions 2 to 6), it is preferable that the metal ion removal agent have a moisture content adjusted to 1% by weight or less (Invention 7).

According to the above invention (Invention 7), by placing a dry metal ion removal agent having a moisture content of 1% by weight or less in a lithium ion battery, transition metal ions generated inside the battery can be promptly absorbed, and even a slight amount of moisture can be promptly absorbed, and therefore, a reaction of a lithium salt with the moisture can be suitably prevented and the generation of hydrofluoric acid can be suppressed.

### Effect of the Invention

The present invention is a lithium ion battery having a metal ion removal agent capable of adsorbing transition metal ions placed in a battery case, and therefore, it is possible to promptly absorb the transition metal ions dissolved from a positive electrode active material due to repeated charge-discharge and the like. Therefore, it is possible to suppress deterioration of a negative electrode and accompanying reduction of battery capacity, and reduction of battery lifetime, and to keep the lithium ion battery in a stable state. In particular, by using a zeolite, a carbon-based material and the like as a metal ion removal agent, dissolution itself of the transition metal from a lithium transition metal oxide can be suppressed.

### BRIEF DESCRIPTION OF DRAWINGS

FIG. 1 is a cross-sectional view schematically showing an internal structure of a lithium ion battery according to one embodiment of the present invention.

FIG. 2 is a graph showing changes in discharge capacity in charge-discharge cycle tests of lithium ion batteries of Example 8 and Comparative Example 1.

### EMBODIMENTS FOR CARRYING OUT THE INVENTION

One embodiment of the present invention shall be hereinafter described in detail with reference to the attached drawings.

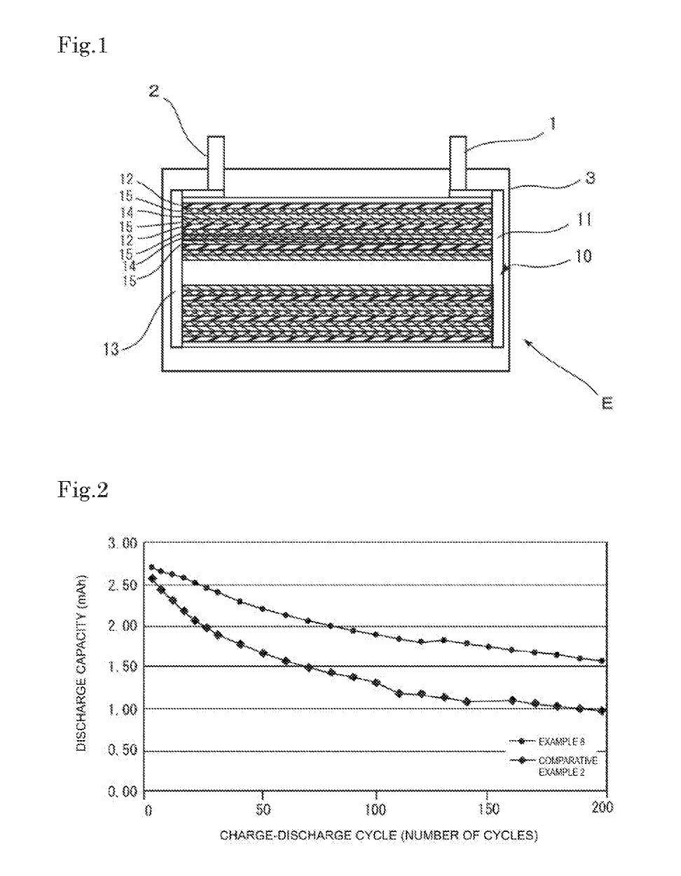

FIG. 1 is a longitudinal cross-sectional view showing a lithium ion battery of the embodiment. In FIG. 1, a lithium ion battery E comprises a positive electrode terminal 1, a negative electrode terminal 2, a battery case (casing) 3, which is an airtight container, and an explosion-proof valve (not shown) optionally formed on an outer peripheral surface of the battery case 3, and an electrode body 10 is accommodated inside the battery case 3. The electrode body 10 has a positive electrode current collector 11, a positive-electrode electrode plate 12, a negative electrode current collector 13, and a negative-electrode electrode plate 14, and the positive-electrode electrode plate 12 and the negative-electrode electrode plate 14 form a laminated structure via a separator 15. Further, the positive electrode terminal 1 and the negative electrode terminal 2 are electrically connected to the positive-electrode electrode plate 12 and the negative-electrode electrode plate 14, respectively. The battery case 3 as a casing is, for example, a rectangular-shaped battery tank can made of aluminum or stainless steel, and has airtightness.

The positive-electrode electrode plate 12 is a current collector where a positive electrode mixture is held on both sides. For example, the current collector is an aluminum foil having a thickness of about 20 μm, and the paste-like positive electrode mixture is obtained by adding polyvinylidene fluoride as a binding material and acetylene black as a conductive material to a transition metal lithium-containing oxide such as LiCoO₂, LiMn₂O₄, LiFePO₄, Li₂FePO₄F, LiCO_{1/3}Ni_{1/3}Mn_{1/3}O₂, Li(LiαNixMnyCoz)O₂, followed by kneading. Then, the positive-electrode electrode plate 12 is obtained by applying this paste-like positive electrode mixture on both surfaces of the aluminum foil, followed by drying, rolling, and cutting in a band shape.

The negative-electrode electrode plate 14 is a current collector where a negative electrode mixture is held on both sides. For example, the current collector is a copper foil having a thickness of 10 μm, and the paste-like negative electrode mixture is obtained by adding polyvinylidene fluoride as a binding material to graphite powder, followed by kneading. Then, the negative-electrode electrode plate 14 is obtained by applying this paste-like negative electrode mixture on both surfaces of the copper foil, followed by drying, rolling, and cutting in a band shape.

As the separator 15, a porous membrane is used. For example, a polyethylene-made microporous membrane can be used as the separator 15. Moreover, as the non-aqueous electrolytic solution to be impregnated into the separator 15, a non-aqueous organic electrolytic solution having lithium ion conductivity is preferable, for example, a mixed solution of a cyclic carbonate such as propylene carbonate (PC) and ethylene carbonate (EC), and a chain carbonate such as dimethyl carbonate (DMC), ethyl methyl carbonate (EMC), and diethyl carbonate (DEC) is preferable. Moreover, the non-aqueous electrolytic solution may optionally be a solution where a lithium salt such as lithium hexafluorophosphate is dissolved as an electrolyte. For example, a mixed solution prepared by mixing ethylene carbonate (EC), ethyl methyl carbonate (EMC) and dimethyl carbonate (DMC) in a ratio of 1:1:1, or a mixed solution prepared by mixing propylene carbonate (PC), ethylene carbonate (EC) and diethyl carbonate DEC) in a ratio of 1:1, to which 1 mol/L of lithium hexafluorophosphate has been added, can be used.

A metal ion removal agent is placed in a gap portion in the battery case (casing) 3 of the lithium ion battery E. In the present embodiment, the metal ion removal agent can promptly absorb a transition metal lithium-containing oxide constituting the positive electrode active material of the positive electrode material, for example, nickel ions (Ni²⁺) which are ions of the transition metal in LiNiO₂. Further, it is preferable that, the metal ion removal agent be able to adsorb ions of the transition metal elements such as Co, Mn and Fe in LiCoO₂, LiFePO₄, LiFePO₄F, LiCO_{1/3}Ni_{1/3}Mn_{1/3}O₂, (LiαNixMnyCoz)O₂ which are lithium transition metal oxides constituting other positive electrode materials. However, depending on the lithium transition metal oxide constituting the positive electrode material, a metal ion removing agent capable of adsorbing ions of the transition metal may be appropriately selected.

An inorganic porous material or a carbon-based material can be suitably used as the metal ion removal agent. Porous silica, a metal porous structure, calcium silicate, magnesium silicate, magnesium aluminometasilicate, zeolite, activated alumina, titanium oxide, apatite, porous glass, magnesium oxide, aluminum silicate and the like can be used as the inorganic porous material.

Moreover, activated carbon such as powdered activated carbon, granular activated carbon, fibrous activated carbon, and sheet-like activated carbon, graphite, carbon black, carbon nanotubes, a carbon molecular sieve, fullerene, nanocarbon and the like can be used as the carbon-based material. As these carbon-based materials, those subjected to various surface treatments for suppressing absorption of moisture can be used. The carbon-based material is capable of promptly absorbing metal ions, and particularly, exhibits an excellent effect in suppressing an increase in the resistance value of a battery.

These inorganic porous materials and carbon-based materials may be used alone, or two or more materials may be used in combination, but a zeolite and activated carbon are particularly effective.

The metal ion removal agent as mentioned above preferably has a specific surface area of 100 to 3,000 m²/g. If the specific surface area is less than 100 m²/g, the contact area with the transition metal ions is so small that sufficient adsorption performance cannot be exhibited. In contrast, if the specific surface area exceeds 3,000 m²/g, not only the effect of improving the adsorption performance of transition metal ions and moisture cannot be obtained, but also the mechanical strength of the metal ion removal agent deteriorates, which is not preferable.

Moreover, the metal ion removal agent preferably has a pore size of 3 Å or more and 10 Å or less. If the pore volume is less than 3 Å, immersion of gas components such as transition metal ions and moisture into the pores becomes difficult. In contrast, if the pore volume exceeds 10 Å, the adsorptive power of the transition metal ions such as nickel ions weakens, and the adsorption in the densest manner within the pores cannot be achieved. As a result, the amount of adsorption decreases, which is not preferable.

Further, when the metal ion removal agent is a zeolite, it is preferable to use a zeolite having an Si/Al element composition ratio in a range of 1 to 5. A zeolite having a Si/Al ratio of less than 1 is structurally unstable, whereas a zeolite having a Si/Al ratio of more than 5 has a low cation content, and the adsorptive power of the transition metal ions such as nickel ions weakens. As a result, the amount of adsorption of the transition metal ions decreases, which is not preferable.

Further, as the zeolite, an A-type, X-type or LSX-type zeolite can be used, but in particular, an A-type zeolite is preferable, and an A-type zeolite where cation portions of the zeolite have been ion-exchanged with Ca is more preferable.

The metal ion removal agent preferably has a moisture removal capability. As a result, since the metal ion removal agent is capable of absorbing a slight amount of moisture present inside the battery, it is possible to prevent a reaction of a lithium salt with the moisture and to suppress generation of hydrofluoric acid, and therefore, it is possible to suppress the dissolution itself of the transition metal from the lithium transition metal oxide. Further, a metal ion removal agent having a transition metal ion adsorption capability and an adsorbent having a moisture removal capability can be blended together and used. However, since a zeolite has both the transition metal ion adsorption capability and the moisture removal capability, a single agent will suffice, which is preferable.

When a metal ion removal agent having an ability to absorb not only transition metal ions but also moisture is used, humidity in the atmosphere is easily absorbed. Further, when this metal ion removal agent absorbs moisture, not only the adsorption performance of the transition metal ions is greatly reduced, but also its ability to absorb moisture decreases. Therefore, in the present embodiment, it is preferable to apply heat treatment to the metal ion removal agent to release the moisture from the metal ion removal agent, and to fill the battery case 3 with the metal ion removal agent in a state in which its ability to absorb moisture has been revitalized. In this case, it is preferable to apply the heat treatment so that the moisture content of the metal ion removal agent is 1% by weight or less. Moreover, it is also possible to eliminate the moisture from the metal ion removal agent to have a moisture content of the metal ion removal agent of 1% by weight or less, by sufficiently dehydrating the non-aqueous organic electrolytic solution to be used in the lithium ion battery E and immersing the metal ion removal agent in the non-aqueous organic electrolytic solution. When the moisture content of the metal ion removal agent exceeds 1% by weight, not only the adsorption performance of the transition metal ions is greatly reduced, but also its ability to absorb moisture becomes insufficient, and the effect of preventing a reaction of a lithium salt with the moisture declines, and battery performance is likely to deteriorate, which is not preferable.

The form of the metal ion removal agent as mentioned above is not particularly limited and a metal ion removal agent in a form of powder, granules or pellets is preferable, and it may be even molded into a sheet, film or the like by mixing with a resin. Further, it may be mixed and dispersed in a non-aqueous electrolytic solution as long as the fluidity of the non-aqueous electrolytic solution is not impaired. Moreover, the amount of blending the metal ion removal agent is not particularly limited, but the metal ion removal agent of about 0.01 to 2 parts by weight per 100 parts by weight of the positive electrode material may be placed around the positive electrode.

The present invention has been described above with reference to the attached drawings, but, the present invention is not limited to the embodiments mentioned above and various modifications can be made. For example, the shape of the lithium ion battery E is not particularly limited, and may have a cylindrical shape.

### EXAMPLES

The present invention shall be described in more detail on the basis of the following specific examples, but the present invention is not limited to the following examples.

### [Confirmation Test 1 of Transition Metal Ion Removal Effect]

### Examples 1 to 3

In 500 of pure water, 2 g of nickel chloride (NiCl₂) was dissolved and diluted 100 times, and a reference solution having a nickel ion concentration of about 10 mg/L was prepared. The aqueous solution in an amount of 50 mL was taken in a beaker and each of 0.01 g, 0.1 g and 1.0 g of A-type zeolite exchanged with Ca as a metal ion removal agent was added to the aqueous solution, and was allowed to stand for 12 hours. The nickel ion concentration of each of the aqueous solutions was then measured. The results are shown in Table 1. Moreover, the nickel ion concentration after allowing the reference solution to stand for 12 hours as a blank value is also shown in Table 1.

TABLE 1

| | | |
|---|---|---|
| | Amount of Metal Ion | Ni²⁺ |
| | Removal Agent Added | Concentration |
| Example No. | (/50 mL) | (mg/L) |

| | | |
|---|---|---|
| Blank | — | 9.32 |

| | | | |
|---|---|---|---|
| Example 1 | 0.01 | g | 5.12 |
| Example 2 | 0.1 | g | 0 |
| Example 3 | 1.0 | g | 0 |

As it is obvious from Table 1, the A-type zeolite exchanged with Ca is found to have an adsorption capability of nickel ions.

### [Confirmation Test 2 of Transition Metal Ion Removal Effect]

### Examples 4 to 6

In 500 mL of pure water, 2 g of nickel chloride hexahydrate (NiCl₂.6H₂O) was dissolved and diluted 100 times, and a reference solution having a nickel ion concentration of about 10 mg/L (reference solution I) was prepared. Moreover, 0.4 g of cobalt chloride hexahydrate (CoCl₂.6H₂O) was dissolved in 200 mL of pure water and diluted 50 times, and a reference solution having a cobalt ion concentration of about 10 mg/L (reference solution II) was prepared. Furthermore, 0.36 g of manganese chloride tetrahydrate (MnCl₂.4H₂O) was dissolved in 200 mL of pure water and diluted 50 times, and a reference solution having a manganese ion concentration of about 10 mg/L (reference solution III) was prepared.

Each of these reference solutions I, II and III in an amount of 50 mL was taken in a beaker, and each of 0.01 g, 0.1 g and 0.2 g of porous carbon materials (EPSIGUARD KC-601P, manufactured by Kurita Mater Industries Ltd., average particle size of 2.5 μm) as a metal ion removal agent was added to each of the reference solutions. Each of the reference solutions was allowed to stand for 12 hours and each of the metal ion concentration was then measured. The results are shown in Table 2. Moreover, the metal ion concentration of each of the reference solutions without adding the porous carbon material after allowing it to stand for 12 hours as a blank value is also shown in Table 2.

TABLE 2

| | Amount of Porous | | Ni²⁺ Con- | Co²⁺ Con- | Mn²⁺ Con- |
|---|---|---|---|---|---|
| Example | Carbon Material | | centration | centration | centration |
| No. | Added (/50 mL) | | (mg/L) | (mg/L) | (mg/L) |
| Blank | — | | 10.2 | 9.8 | 10.2 |
| Example 4 | 0.01 | g | 10.0 | 10.0 | 9.3 |
| Example 5 | 0.1 | g | 8.7 | 8.5 | 6.7 |
| Example 6 | 0.2 | g | 5.9 | 6.4 | 4.9 |

As it is obvious from Table 2, the porous carbon material has a transition metal ion adsorption capability, and it is understood that the transition metal ions can be eliminated in amounts of 15 mg/g for nickel ions, 13 mg/g for cobalt ions and 35 mg/g for manganese ions per 1 g.

### [Confirmation Test of Moisture Removal Effect]

### Example 7

In a 100 ml vial, 1 g of an A-type zeolite exchanged with Ca having a moisture content adjusted in advance to 1% by weight or less as a metal ion removal agent was taken, and 50 mL of a commercially available electrolytic solution (electrolytic solution (ethylene carbonate (EC):dimethyl carbonate (DMC):ethyl methyl carbonate (EMC) mixed in a volume ratio of 2:4:4) in which 1 mol/L of LiPF₆ had been dissolved) was injected under a nitrogen atmosphere, and further, 5 μL of pure water was added dropwise thereto.

The results of measuring the concentration of fluoride ions (F⁻) (corresponding to hydrofluoric acid concentration) of the electrolytic solution after a predetermined time was passed are shown in Table 3. As a Reference Example, the measurement result of the concentration of fluoride ions (F⁻) in the case of using an electrolytic solution alone is also shown in Table 3.

### Comparative Example 1

The concentration of fluoride ions (F⁻) of the electrolytic solution was measured in the same manner as in Example 7 except that the metal ion removal agent was not used. The result is also shown in Table 3.

TABLE 3

| | | F⁻ |
|---|---|---|
| | | Concentration |
| Example No. | Sample Composition | (mg/L) |
| Example 7 | Electrolytic solution + | <10* |
| | pure water + metal ion | |
| | removal agent | |
| Comparative | Electrolytic solution + | 120 |
| Example 1 | pure water | |
| Reference | Electrolytic solution only | 40 |
| Example | | |

*Less than the detection lower limit value (10 mg/L)

As it is obvious from Table 3, in Comparative Example 1, where pure water was added to the electrolytic solution, the concentration of fluoride ions was greatly increased as compared with that of the Reference Example, where there was only the electrolytic solution. This is considered to have resulted from the generation of hydrofluoric acid from a reaction of with the moisture. In contrast, in Example 4, where a metal ion removal agent was added, the concentration of fluoride ions was less than the detection lower limit value, which was less than that of the Reference Example. This is considered to have resulted from the fact that the metal ion removal agent not only has a hydrofluoric acid removal capability, but also has a moisture removal capability, and therefore the generation itself of the hydrofluoric acid is suppressed.

### [Charge-Discharge Cycle Test]

### Example 8

The following materials were prepared as materials for a lithium ion battery for testing.

Flat cell: Manufactured by Hohsen Corp, electrode area of about 2 cm² (Φ16 mm)

Positive electrode: Ternary (LiNiCoMnO₂), N:M:C=1:1:1

Negative electrode: Spherical crystalline graphite

Separator: PP separator, thickness of 20 μm

Electrolytic solution: 1 mol/L of LiPF₆ dissolved in a mixed solution of ethylene carbonate (EC):ethyl methyl carbonate (EMC)=3:7

Metal ion removal agent: Ca-exchanged A-type zeolite (adjusted to a moisture content of 1% by weight or less)

A metal ion removal agent was added to an electrolytic solution at a rate of 0.02 g/mL, while a positive electrode, a negative electrode and a separator were dried under reduced pressure at 90° C. for 1 hour or more with a glass tube oven. Further, these materials were assembled in a glove box under an argon gas atmosphere at a dew point of −30° C. or lower to prepare a lithium ion battery material for testing.

The lithium ion battery was connected to a charge-discharge test unit (Charge-Discharge Battery Test System PFX2011, manufactured by Kikusui Electronics Corporation), and charge-discharge cycles were repeated 200 times under the conditions of charge-discharge amperage of 0.5 C, constant-voltage charge of 4.2 V×60 minutes and discharge cut-off voltage of 3.2 V, and changes in discharge capacity were measured. The results are shown in FIG. 2.

### Comparative Example 2

A lithium ion battery material for testing was prepared in the same manner as in Example 8 except that the metal ion removal agent was not added to the electrolytic solution.

The lithium ion battery was connected to the charge-discharge test unit, and charge-discharge tests were conducted and changes in discharge capacity were measured under the same conditions as those of Example 8. The results are also shown in FIG. 2.

As it is obvious from FIG. 2, in Example 5, where the metal ion removal agent was used, the discharge capacity was reduced only by about 40% even when charge-discharge was repeated 200 times, whereas in Comparative Example 2, where the metal ion removal agent was not used, the discharge capacity was reduced to 60% or less. It is considered to have resulted from the fact that the transition metal (nickel, cobalt and manganese) ions generated in the battery were dissolved and precipitated inside the battery, causing the battery performance to deteriorate.

### DESCRIPTION OF REFERENCE NUMERALS

1 Positive electrode terminal
2 Negative electrode terminal
3 Battery case (casing)
10 Electrode body
11 Positive electrode current collector
12 Positive-electrode electrode plate
13 Negative electrode current collector
14 Negative-electrode electrode plate
15 Separator
E Lithium ion battery

1. A lithium ion battery comprising a laminated body sealed in a battery case, the laminated body comprising a positive electrode, a negative electrode, and a separator and being impregnated with a non-aqueous electrolytic solution, and lithium ions in the non-aqueous electrolytic solution being responsible for electrical conduction, wherein a metal ion removal agent is provided in the battery case.

2. The lithium ion battery according to claim 1, wherein the metal ion removal agent has a metal ion removal capability as well as a moisture removal capability.

3. The lithium ion battery according to claim 1, wherein the metal ion removal agent is made of an inorganic porous material.

4. The lithium ion battery according to claim 3, wherein the inorganic porous material is made of a zeolite.

5. The lithium ion battery according to claim 4, wherein the zeolite is an A-type zeolite ion-exchanged with Ca.

6. The lithium ion battery according to claim 1, wherein the metal ion removal agent is made of a carbon-based material.

7. The lithium ion battery according to claim 2, wherein the metal ion removal agent has a moisture content adjusted to 1% by weight or less.
